(19) United States
(12) Patent Application Publication
(10) Pub. No.: US 2017/0211964 A1
(43) Pub. Date: Jul. 27, 2017

(54) MEASURING DEVICE FOR MEASURING A MEASURED VARIABLE

(71) Applicant: KROHNE S.A.S., Romans-sur-Isère (FR)

(72) Inventors: Vincent Milhaud, Valence (FR); Denis Graillat, Mours Saint Eusèbe (FR); Vincent Pichot, Romans-sur-Isère (FR)

(73) Assignee: KROHNE S.A.S., Romans-sur-Isère (FR)

(21) Appl. No.: 15/412,344

(22) Filed: Jan. 23, 2017

(30) Foreign Application Priority Data
Jan. 21, 2016 (DE) 10 2016 101 062.6

(51) Int. Cl. G01F 23/284; G01D 11/00

(52) U.S. Cl. CPC G01F 23/284; G01D 11/00

(57) ABSTRACT

A measuring device for measuring a measured variable with a sensor device (2) and an output device, which generates at least one output signal based on at least one sensor signal of the sensor device (2). To provide a measuring device that is flexible in terms of signal output, the output device has at least two signal outlets (4, 5) for outputting of the at least one output signal.

### BACKGROUND OF THE INVENTION

Field of the Invention

The invention relates to a measuring device for measuring a measured variable having a sensor device and an output device. The output device thereby generates at least one output signal based on at least one sensor signal of the sensor device. Examples of the measured variable, whose value is to be determined with the measurement, are fill level, flow, mass flow, temperature, pH value, or conductivity of a medium. A medium, whose measured value is to be determined, is, for example, a bulk material or a liquid.

Description of Related Art

In modem process automation, measuring devices are used to control or monitor processes based on the measured variables to be determined. For further observation, measuring devices are divided into two components: sensor device and output device.

The sensor device generates a sensor signal dependent on the measured variable, which is converted into a measured value by the output device or which is at least transmitted in a data format suitable for the data protocol used. In this manner, for example, the fill level of a medium can be determined using the running time of an electromagnetic signal or the flow of a medium is obtained from a phase shift.

Different protocols and different technical signal carriers are known for the output signals. For example, current, frequency and impulse outputs are known. For example, so-called current signals are known, in which the measured value for the measured variable is transmitted via the current located within a certain range (usually between 4 mA and 20 mA). It is also known to trigger a relay in order indicate that a value has reached or fallen below a given threshold value. In the last example, these measuring devices are so-called level switches.

Many measuring devices allow continual measurement of a measured variable and can simultaneously be used as a level switch, if the information needed is only that the measured variable has reached or fallen below a certain value. The information that a limit level has or has not been reached is then, for example, a signal derived from the actual sensor signal. Depending on the purpose, the measuring device is provided with suitable output devices, wherein the sensor device can be the same in each case. This, however, makes it necessary to have several output devices and, in each case, only one use is possible.

### SUMMARY OF THE INVENTION

The object of the invention is to provide a measuring device that is flexible in terms of signal output.

The measuring device according to the invention, in which the object is achieved, is wherein the output device is has at least two signal outlets for outputting of the at least one output signal. Due to this measure, a substantial amount of flexibility is achieved although only one output device is implemented in the measuring device. A plurality of applications can be implemented with the measuring device designed in this manner, which are the subject matter of the following designs.

It is provided in one design of the measuring device that the two signal outlets are used for the output of output signals of differing signal types. Therefore, the output device allows the output signal (or differing output signals) to be emitted in the form of at least two different types of signals. The measuring device can, thus, for example, be operated in two different modes: e.g., for continual measurement of the measured variable or, alternatively, as level switch. Alternatively, the measuring device can emit the measured value via two different protocols. Overall, the measuring device allows the simple conversion of the type of signal output in that the required type of signal is chosen in each case.

In one design, the two types of signals are analog signals and digital signals. A first signal outlet is used for the output of analog signals and a second signal outlet is used for the output of digital signals. In particular, the analog signal is a current signal and the digital signal is a digital signal with two values, i.e., a binary signal. Thereby, the current signals are the signals known from the prior art, the measured value being output via their currents. The binary signals are the signals that, for example, communicate whether or not a limit level as been achieved.

It is provided in a further development that a single sensor signal is emitted via the two signal outlets by two output signals of differing signal types. Thus, without additional effort, a response can be made to different external demands to transmit the signal. A redundancy can also be implemented when both signal outlets are used.

It is provided in an alternative design that the two signal outlets are used for the output of output signals of identical signal types. For example, it is then possible to simultaneously implement two current outlets. In a particular further development, it is provided that two different output signals are emitted via the two signal outlets, wherein the different output signals are based either on two different sensor signals or on one sensor signal and on one signal derived from this sensor signal. This could be, for example, the fill level and the temporal change of the fill level, i.e., the speed of change of the fill level.

In one design, the first signal outlet, via which current signals are emitted, are used for energy supply of the output device. In one design, the energy supply of the entire measuring device is implemented via the first signal outlet. In an alternative design, it is provided that the sensor device is supplied with energy separately from the output device.

In order to generate the binary signal, one design provides that the second signal outlet has at least one relay. Thereby, it is provided in one design that the relay has one coil and that the coil is connected in series with the first signal outlet.

In one design, at least one transformation device is provided as part of the measuring device. The transformation device is thereby designed that it receives the sensor signal and generates the output signal. In one design, the transformation device is designed so that it generates the output signal in that it sets a current value. The size of the current value thereby depends on which type of signal the output signal should be. Thus, in the case that the output signal is to be emitted as an analog current signal, the transformation device sets a current value within a pre-determinable current range (e.g., between 4 mA and 20 mA). If the output signal is to be emitted as a binary signal, the transformation device sets a current value outside of the above current range.

A further design is dedicated to solving the problem that, in particular for applications that are safety critical, the measuring device is to monitor itself and to determine whether the signals emitted as actual signals are the same as the signals to be emitted as target signals or the deviation at least remains within a predetermined tolerance range. Thus, in the case of current signals, it is known to read them as actual signals, i.e., to measure the output currents and to compare them to the pre-determined target value.

For this, the measuring device, in one design, has at least one read-back device, via which the emitted output signals are read back, and converts the current of the read-back output signal into a frequency of a pulse width modulation (PWM) signal. The PWM signal is additionally used as an information medium in the following design. A signal-modifying device is therefore provided to modify the PWM signal, which provides a duty cycle of the PWM signal. In one design, the signal-modifying device is connected to the relay of the second signal outlet. The connection is, in particular, of such type that the state of the relay affects the signal-modifying device or, respectively the operation of the signal-modifying device. Thus, in one design, the specification of the duty cycle by the signal-modifying device depends on which binary signal the second signal outlet emits.

In detail, there is a plurality of possibilities for designing and further developing the invention as will be apparent from the following description of embodiments in conjunction with the accompanying drawings.

### BRIEF DESCRIPTION OF THE DRAWINGS

FIG. 1 is a schematic representation of a first version of a measuring device according to the invention,

FIG. 2 is a schematic representation of a second version of the measuring device and

FIG. 3 is a schematic representation of part of a third version of the measuring device.

### DETAILED DESCRIPTION OF THE INVENTION

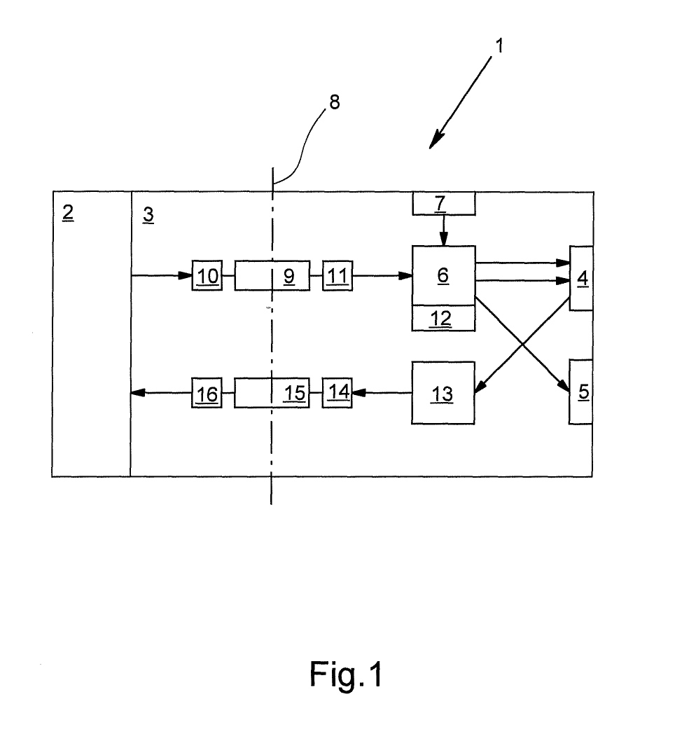

A first version of a measuring device 1 according to the invention is schematically illustrated in FIG. 1, partly in the form of a block diagram. The measured variable determined therewith is, as an example, the fill level of a medium—not shown here—that is determined using the running time method via guided microwaves.

A sensor device 2 is provided for the actual measurement, which generates a sensor signal based on a measurement. The output device 3 upstream from the sensor device 2 receives the sensor signal and generates an output signal, which, for example, is transmitted to a higher-ranking control room—not shown here—or to another peripheral.

Two signal outlets 4, 5 are provided for outputting of output signals, which allow for the outputting of two different types of signals. The first signal outlet 4 allows for the output of current signals and is thereby used for energy supply of the output device 3 in that a current loop results. Current signals are standardized signals, in which information can be communicated via the current—in particular, between the limit values 4 mA and 20 mA. The second signal outlet 5 allows for outputting of so-called binary signals. This is a sort-of true/false signal. This transmits, for example, whether a predetermined threshold value has been exceeded.

The generation of the output signal and the use of the appropriate signal outlet 4, 5 are carried out by a transformation device 6, which receives the sensor signal from the sensor device 2. A setting device 7 indicates which type of signal the output signal is to be. Thus, the transformation device 6 is influenced via the setting device, and in particular, the type of signal can be chosen. If a binary signal is chosen as a type of signal, then, in the illustrated embodiment, a threshold value is also set by the setting device 7, the sensor signals being processed by the transformation device 6 relative to it. The transformation device 6 in the illustrated design generates either a 4 . . . 20 mA signal from the sensor signal as current signal or a binary signal by comparison with a pre-determinable threshold value. The outputting of the output signal generated in this manner then occurs via the first signal outlet 4 or the second signal outlet 5.

The sensor signal is transmitted over and beyond a galvanic separation 8, which runs through the output device 3 here, via an optical-coupler 9. Thereby, the so-called pulse width modulation is used and a so-called PWM signal is generated and transmitted. A PWM signal is a rectangular signal having a fixed period duration, which oscillates between two different voltage levels; the signal is virtually switched on and off in rapid succession. The signal is thereby characterized by two values: the duty-cycle describes the portion of the time in which the signal is switched on, i.e., has a higher value relative to the period duration. The frequency describes the velocity of the change between both levels. The PWM signal is generated by a signal-forming device 10 from the digital sensor signal of the sensor device 2, transmitted by means of the optical-coupler 9 and is transformed back into a digital signal by a signal-transforming device 11.

Energy supply of the components of the output device 3 on the side of the galvanic separation 8, which is comprised of both signal outlets 4, 5, is ensured by the first signal outlet. A voltage-regulating device 12 is in operative contact hereto, via which the maximum required current supply of the components—partially not shown—is regulated to a maximum of 1 mA. In the shown design, the sensor device 2 has its own energy supply—not shown here.

Additionally, another read-back device 13 is provided, via which the current output signal applied at the first signal outlet 4 is read back. The read-back signal is transmitted over the galvanic separation 8 to the sensor device 2. The signal is thereby transmitted in the form of a PWM signal, wherein a signal-forming device 14, an optical-coupler 15 as well as a signal-transforming device 16 are used. The transmitted, read-back signal is compared in the sensor device 2 to the actual sensor signal as target signal.

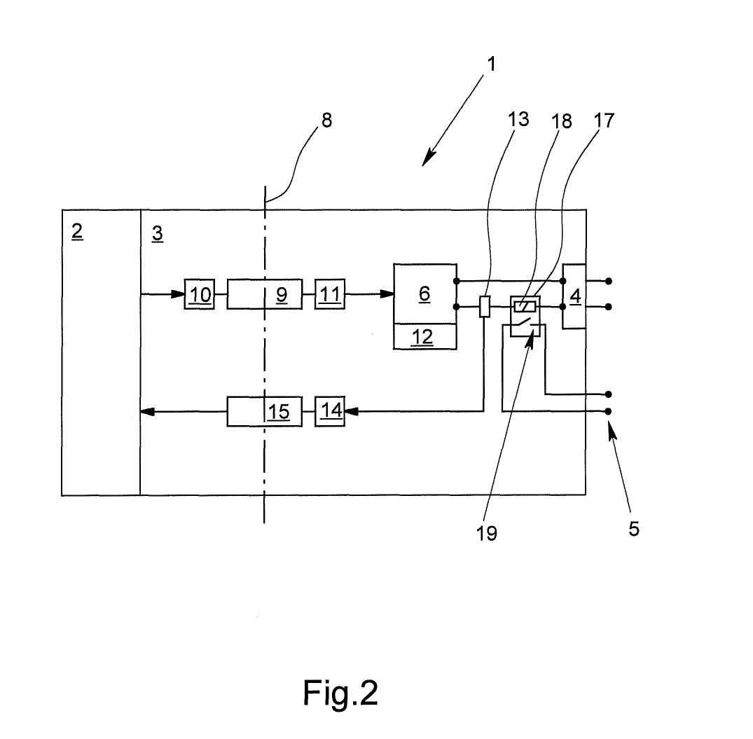

The measuring device 1 of the variation shown in FIG. 2 also has a sensor device 2 that transmits a sensor signal to the output device 3, so that an output signal can be generated therefrom.

The sensor signal is transmitted over the galvanic separation 8 in the form of a PWM signal. For this, the signal-forming device 10, the optical-coupler 9 and the signal-transforming device 11 are used. Thus, a PWM signal is generated from the sensor signal, transmitted via the optical-coupler 9 and then transformed into a digital signal again. The transformation device 6 receives the sensor signal and generates—depending on the chosen type of signal—a current signal via the first signal outlet 4 or a binary signal via the relay 17 at the second signal outlet 5. The transformation device 6 compares the information of the sensor signal with a predetermined threshold value for generating the binary signal.

Two lines are provided between the transformation device 6 and the first signal outlet 4, which are used for generating the current loop required for the output of the current signal. The coil 18 of the relay 17 is connected along one of the lines and, thus, in series. The control circuit of the relay 17 is thus provided within the connection between the transformation device 6 and the first signal outlet 4.

Energy supply of the outlet device 3 is implemented via the first signal outlet 4. Energy supply is, for example, such that a voltage of 24 V is required for the measuring device 1. It is ensured by the voltage-regulating device 12 that the components of the outlet device 3 do not exceed a maximum current demand. This, for example, is a value of 1 mA. If a higher current is provided by the current signal from the side of the current loop of the outlet device 3, it is then converted into heat by the voltage-regulating device 12 in the shown design.

If the transformation device 6 generates a current signal as output signal, current level of which is accordingly between 4 mA and 20 mA as pre-definable current range, then the coil 18 of the relay 17 does not react and does not switch the load circuit 19.

Should a binary signal be generated as output signal for the second signal outlet 5, then the transformation device 6 determines whether a logical value 1 or a logical value 0 should be emitted based on the sensor signal and the pre-determinable threshold value. It is thus determined, whether the measured value is above or below the threshold value. Based on this, the transformation device 6 switches a current that is either below the 4 mA lower limit of the current signals (e.g., 1 mA) or above the 20 mA upper limit of the current signals (e.g., 40 mA or 30 mA). In particular the upper current value—here 40 mA or 30 mA—is measured so that the coil 18 of the relay 17 reacts and the load circuit 19 is accordingly switched. The load circuit 19 is thus, in particular, also part of the second signal outlet 5.

The output of two different types of signals is implemented overall such that either a current—preferably linear—is set between 4 mA and 20 mA (as an example for a current range) or that a current value is set that is located outside of this current range—preferably 1 mA and 40 mA or 30 mA. The lower value is thereby the standby current, which, in particular, the output device 3 requires for operation. The upper value is, in particular, provided such that the coil 18 of the relay 17 can be switched with it.

The read-back device 13 is arranged in series between the transformation device 6, the coil 18 of the relay 17 and the current loop of the first signal outlet 4. The read-back device 13 reads the current applied at the first signal outlet 4 back and transmits the current of the output signal in the frequency of the PWM signals, which is transmitted to the sensor device 2.

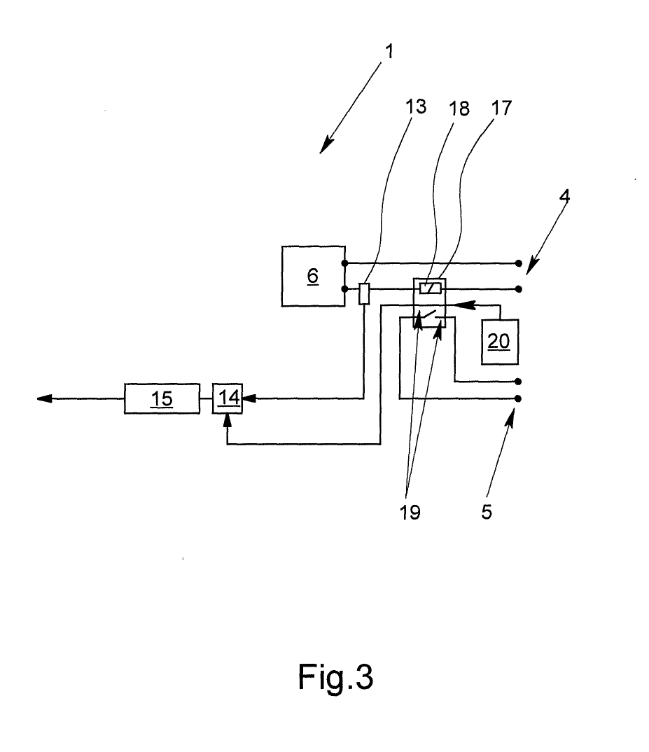

For better understanding, only a part of a measuring device is shown in FIG. 3. In a further development of the design of the measuring device of FIG. 2, not only the output signal of the first signal outlet 4 is monitored, but also the second signal outlet 5.

Here, the relay 17 has two load circuits 19 that are switched by the coil 18. The lower load circuit 19 is a part of the second signal outlet 6 and the upper load circuit 19 is a part of the monitoring of the output signals or the monitoring of the components used for signal output.

For the last-mentioned purpose, a signal-modifying device 20 is additionally provided, which affects the signal-forming device 14 via the load circuit 19—shown schematically here. The connection of the signal-modifying device 20 to the signal-forming device 14 is thereby dependent on the switching of the relay 17, i.e., the connection exists or is interrupted depending on the state of the relay 17. Thus, the PWM signal transmitted to the sensor device 2 allows for a relatively simple and reliable transmission of the state of the relay 17 as additional information. The signal-modifying device 20 in the shown example thereby affects the duty cycle of the PWM signal. In other words: the impact of the signal-modifying device 20 on the PWM signal is seen depending on the state of the relay 17, so that inversely, the state can be inferred from the PWM signal.

Behind the optical-coupler 15, information about the current applied at the first signal outlet 4 thus results from the frequency of the PWM signal as information carrier of the feedback output signal and information about which state the relay 17 is in results from the duty-cycle. The two characterizing variables of the PWM signal are thus used for transmitting two values.

What is claimed is:

1. Measuring device for measuring a measured variable, comprising:
a sensor device and
an output device,
wherein the output device generates at least one output signal based on at least one sensor signal of the sensor device, and
wherein the output device has at least two signal outlets for outputting of the at least one output signal.

2. Measuring device according to claim 1, wherein the two signal outlets are adapted to output signals of different signal types.

3. Measuring device according to claim 2, wherein the two different types of signals are analog signals and digital signals, wherein a first signal outlet serves for outputting of the analog signals and wherein a second signal outlet serves for outputting of the digital signals, the analog signal being a current signal and the digital signal being a binary signal.

4. Measuring device according to claim 2, wherein a single sensor signal is emitted via the two signal outlets by two output signals of differing signal types.

5. Measuring device according to claim 1, wherein the two signal outlets serve for outputting of output signals of identical signal types.

6. Measuring device according to claim 5, wherein two different output signals are emitted via the two signal outlets, and wherein the different output signals are based either on two different sensor signals or on one sensor signal and on one signal derived from the sensor signal.

7. Measuring device according to claim 1, wherein the first signal outlet serves for supplying energy to the output device.

8. Measuring device according to claim 1, wherein the second signal outlet has at least one relay, and wherein a coil of the relay is connected in series with the first signal outlet.

9. Measuring device according to claim 3, further comprising at least one transformation device, wherein the transformation device receives the sensor signal and creates the output signal as a current value within a given current range

10. Measuring device according to claim 3, further comprising at least one transformation device, wherein the transformation device receives the sensor signal and creates the output signal as a binary signal.

11. Measuring device according to claim 1, further comprising at least one read-back device which converts at least one current strength of the output signal emitted by the output device into a frequency of a pulse width modulation signal.

12. Measuring device according to claim 10 further comprising a signal-modifying device that provides a duty cycle of the pulse width modulation signal.

13. Measuring device according to claim 11, wherein the signal-modifying device is connected to a relay of the second signal outlet.

14. Measuring device according to claim 1, wherein the sensor device is supplied with energy separately from the output device.
